(19) United States
(12) Patent Application Publication
(10) Pub. No.: US 2022/0390693 A1
(43) Pub. Date: Dec. 8, 2022

(54) MICRO-OPTICAL INTERCONNECT COMPONENT AND ITS METHOD OF FABRICATION

(71) Applicant: CSEM CENTRE SUISSE D'ELECTRONIQUE ET DE MICROTECHNIQUE SA - RECHERCHE ET DÉVELOPPEMENT, Neuchâtel (CH)

(72) Inventors: Roger KRÄHENBÜHL, Arlesheim (CH); Angélique LUU-DINH, Mulhouse (FR); Amir Hossein GHADIMI, Chavannes-près-Renens (CH)

(21) Appl. No.: 17/760,999

(22) PCT Filed: Sep. 17, 2020
(86) PCT No.: PCT/EP2020/076021

§ 371 Date: Mar. 16, 2022

(30) Foreign Application Priority Data
Sep. 20, 2019 (EP) 19198663.7

(51) Int. Cl. G02B 6/42

(52) U.S. Cl. CPC G02B 6/4214; G02B 6/4228

(57) ABSTRACT

Disclosed is a micro-optical interconnect component including an optical platform including, arranged onto a substrate, at least one optical alignment structure fixing an optical component and/or arranged as alignment structure to adapt another interconnect component. The optical platform includes a light deflecting element, having a total volume of less than 1 mm3, and made of a material having a refractive index higher than 1. The light deflecting element includes a face, facing the optical alignment structure, and has a curved reflecting surface so that an incident light beam onto the first face is deflected by an angle between 60° and 120°, the incident light beam may be provided from the outside or the inside of the substrate. Also disclosed are optical devices including at least one optical interconnect component and to optical systems including at least one optical device, as well as a batch fabrication process of the optical interconnect component

### TECHNICAL FIELD

The invention relates to the field of optical interconnect devices comprising optical couplers and optical waveguides, such as optical waveguides and optical fibers that are integrated on a chip or an optical or photonics platform.

More precisely, the invention relates to micro-optical devices comprising integrated fiber-to waveguide couplers and reflective optical micro-components with smooth curved surfaces.

The optical interconnect component comprises mechanical alignment structures in addition to a reflective curved surface, allowing for simple “plug-and-play” insertion of optical elements and/or optical fibers.

The invention also relates to methods of batch-fabrication of the optical interconnect components.

### BACKGROUND OF THE ART

In several markets relying on compact optical systems such as the telecom, data-com markets, metrology and photonics sensors, low cost compact optical systems and devices are in constant demand to provide higher data rates, together with higher density and also to provide a high reliability in harsh environments. Integrated photonics circuits (PICs) profit from the increase in system integration and the substantial enhanced intensity by reducing the optical mode size. This is especially useful for nonlinear effects and sensing but also for telecommunication, space, quantum and other applications.

A typical challenge associated to Photonic Integrated Circuits (PICs) is the ability to couple light in and/or out of the chip by an optical fiber or an optical fiber bundle. Optical fibers can be used to direct or collect light to or from photonics chips realized on typically Si substrates S, S1, S2. In addition, they are a preferred option for data transport over long distances. Currently, as illustrated in FIGS. 1-2 the available technologies for input/output coupling are all based on chip-scale approaches and involve precise active alignment of optical fibers, arranged on platforms FP1, FP2 (FIG. 2). In some variants illustrated in detail in FIG. 1, the light provided by an optical fiber SF is coupled to a “grating pattern” G or a “tapered waveguide” W, possibly arranged on a buried oxide layer BO, at the edge of an optical platform, typically a photonic chip, by continuously monitoring the transmission and trying to maximize the transmission and fixing the arrangement by for example gluing or welding. This “serial process” has to be repeated sequentially for every chip and leads to significant increase in the packaging cost of the final product. Usually, photonics packaging accounts for up to 80% of the total the cost of a photonics chip. It is referred her to the following publication: E. Fuchs et al, Journal of Lightwave Technology, 2006, doi:10.1109/JLT.2006.875961.

Also, butt-coupling solutions for light coupling from and/or into optical fibers require too high volumes of space and/or additional fiber support structures and it is difficult to assure a reliable connection which most often relies to the use of glues. With the transition of optics being ever closer to the devices, e.g. for connected systems and even to monolithic chip integration, there is an increasing demand to provide miniaturized optical solutions. In particular, interconnections are required to couple to active optical devices such as lasers, LEDs and detectors, as well as to waveguides in electro-optical boards, and to waveguides in photonic integrated circuits (PIC). Also, in the case of chip to chip coupling for heterogynous integration of PICs made of different materials on the same package, it is essential to have compact non-coplanar optical interconnectors. Several types of in-plane compact connectivity solutions rely on diffractive gratings (ref. 1), reflective curved mirrors (ref. 2), micro-lenses on 45°-angled fibers (ref. 3) or facet mirrors arranged on V-grooved silicon optical benches (ref. 5).

However, most of these solutions provide unacceptable small coupling efficiencies, need active alignment and/or require complicated manufacturing methods or still relay on a serial process which increase the cost of final device.

Recently, two photon lithography techniques have been used to try to solve the above-mentioned problems. These techniques require a serial process and are very time consuming and not scalable. For example, active alignment of optical fiber arrays to grating couplers is in the order or 15-20 min per facet. This implies a packaging cost that is more than ten times the cost of the optical chip. The fabrication of a single 3D structure with two-photon lithography might take even longer than that (even up to an hour) which does not allow to realize up to tens of thousands of devices on a wafer at a reasonable cost. Another problem with two-photon lithography is that it does not result in smooth surfaces and results in unacceptable optical losses.

Another issue is related to all solutions that use organic photoresist. These materials are not stable and degrade over time and have very limited transparency window and are not compatible with a broad range of wavelengths. Furthermore, such materials have a too low temperature operating range.

Having a low cost and scalable wafer level parallel solution for an in-plane optical component-to-chip coupling, such as fiber-to-chip coupling, that allows to fabricate thousands of couplers at once and require no active alignment for the optical fiber insertion (plug-and-play) could be a game-changer for the photonics industry by reducing the cost and complexity of packaging.

### SUMMARY OF THE INVENTION

It is an objective of the invention to provide an innovative improved solution for optical devices that rely on the interconnection of optical components which are configured on an optical platform such as a photonic chip, and wherein light beams have to be deviated by very small deflectors, typically having volumes smaller than 1 mm³, by deflection angles of typically between 70°-120°. The solution provided by the interconnect micro-component of the invention allows to achieve a wide range of deflection configurations arranged on an optical platform and with a very high efficiency and at the same time enabling possible beam shaping such as focusing or making divergent light beams collimated after reflection. Together with micro-deflectors arranged on the same substrate, the solution comprises optical alignment structures that are very precisely aligned and mechanically very robust and stable relative to the micro-deflectors, to provide easy and stable assemblies between the optical micro-components and the micro-deflector. The invention proposes a method of fabrication of micro-deflectors simultaneously with optical alignment structures for interconnections at a low cost as they can be batch-processed. Wafer-scale micro-structure arrays with integrated TIR surfaces represent a low cost and high-performance solution with respect to the standard approach based on additional optical components (such as micro-prisms) placed individually at chip level. On the one hand, the optical interconnect of the invention decreases the bill-of-material, since the direct wafer level replication is an efficient, parallel and potentially high-volume process. On the other hand, it suppresses the need for precise, hence costly, optical alignment, which will be directly integrated into the fabrication process by the imprint of self-alignment structures. Finally, the implementation of such a replication technology enables the production of folded micro-optical interconnects with extreme compactness, thus providing significant technical advantages and degrees of freedom both to component suppliers and to device/system integrators

In a first aspect the invention is achieved by a micro-optical interconnect component comprising an optical platform comprising a substrate defining a first substrate surface to adapt optical structures and a second surface opposite to said first surface. The optical platform comprises, arranged onto said first substrate, at least one optical alignment structure. Said optical alignment structure is adapted to fix an optical component and/or arranged as alignment structure to adapt another interconnect component.

The optical platform comprises a light deflecting element arranged on said first surface and being made of a material having a refractive index higher than 1.

The light deflecting element comprises a first face, facing said optical alignment structure, and a second face facing said substrate to a second side, said first and said second side being connected by a curved surface being an optically reflecting surface.

The light deflecting element has a shape so that an incident light beam onto said first or second surface is deflected by an angle between 60° and 120°, said incident light beam may be provided from the outside or the inside of said substrate (10).

The light deflecting element has a total volume of less than 1 mm³. Very small deflectors are well adapted to be integrated in front of very small optical components such as micro lasers or cores of optical fibers.

In an embodiment said light deflecting element is configured to reflect more than 80% of light provided from said first face to said second surface or vice versa. A high optical reflectivity and smooth surface allows to provide microscopic small deflectors so that low light losses may be provided between optical components such as optical fibers and embedded waveguides.

In an embodiment said optical component is an optical waveguide and wherein the alignment structure is a waveguide alignment structure comprising at least two opposite walls to fix at least a portion of a length of said optical waveguide between said walls, said waveguide alignment structure facing said light deflecting element, to the side of said first face.

Wafer-scale micro-structure arrays with integrated curved reflective surfaces represent a low cost and high-performance solution with respect to the standard approach based on additional optical components (such as micro-prisms) placed individually at chip level. On the one hand, the optical interconnect of the invention decreases the bill-of-material, since the direct wafer level replication is an efficient, parallel and potentially high-volume process. On the other hand, it suppresses the need for precise, hence costly, optical active alignment, which will be directly integrated into the fabrication process by the replication of self-alignment structures. Moreover, the well-controlled curved surface of the micro-mirror enables conversion of the spot size (e.g. focusing) of the optical structure on the substrate (e.g. grating coupler, photodetector or VECSEL) and the optical component, (e.g. optical fiber and alignment to its core). Finally, the implementation of such a replication technology enables the production of folded micro-optical interconnects with extreme compactness, thus providing significant technical advantages and degrees of freedom both to component suppliers and to device/system integrators. The simultaneous fabrication of light deflective elements and fiber alignment structures allow a very precise registration between these on large arrays/full wafer surface.

In an embodiment waveguide (20) is one of: an optical fiber, an optical fiber bundle or a multicore fiber. The use of optical fibers connected to PICs allows to provide systems in which the light source or the detector may be arranged at a great distance to a PIC or to provide fiber coils for sensing or other applications.

In an embodiment said curved surface has an aspherical shape, defined in at least one of its cross-section planes. The use of an aspherical shape, in at least one cross-section allows to provide a precise beam shaping of the reflected light by the optical reflector and achieve, for example, very small spot sizes and/or highly collimated light beams and/or light beams having a specified numerical aperture. For example, in advantageous realization, said light deflecting element is configured to focus an incident parallel beam on its first or second surface into a light spot having a largest dimension of less than 50 μm, preferably less than 20 μm, more preferably less than 10 μm at said second, respectively first, surface.

In an embodiment said optical substrate is made of a material chosen from: silicon, SOI (Silicon on Insulator), SiN (silicon nitride), glass, quartz, LiNbO₃, LNOI (lithium niobate on insulator), barium Titanate Oxide (BTO), InP, GaP, GaAs substrate or a combination of them.

Using such different types of substrate materials allows to provide active and passive photonic integrated circuits working in different wavelength ranges and/or having different functionalities and characteristics and enables the inversion to serve and be compatible with different commercially available PIC platforms.

In an embodiment said alignment structure is made of a material chosen from: polymer, glass, silicon, UV-curable materials such as sol-gels, UV-resins, UV-cross linkable polymers, monomers or oligomers, elastomers, or a combination of them. Different types of materials for the alignment structure allows to provide a wide design flexibility for the alignment and fixation of optical components, in function of the nature of these components. The choice will depend if for example glass or plastic optical components have to be aligned or fixed, their geometries, alignment tolerances and assembly procedures.

In an embodiment said light deflecting element is made of a material chosen from: polymer, glass, silicon, UV-curable materials such as sol-gels, uv-resins, uv-crosslinkable polymers, monomers or oligomers, elastomers, reflective coatings, anti-reflective coatings or a combination of them. The material will be chosen in function of the application and the wavelength. As an example, silicon may be used for infrared applications to realize at wafer level a basis for the light deflecting elements, onto which a UV-crosslinkable sol-gel transparent in the infrared is UV-crosslinked in registration to this basis to make a light deflecting elements composed of two strata of different material. Optionally anti-reflective coating may be added to the first face of the light deflective elements and/or a reflective coating may be added to the curved face or a portion of it.

In an embodiment a grating is fabricated on said substrate so that it faces at least partially said optical deflector. The grating is realized preferably in a layer of silicon (Si), or a layer of Si3N4 or a layer of LiNbO3 or a layer of InP or a layer of GaP or a layer of GaAs or a layer of glass or a polymer layer glass. The grating is manufactured in the same layer as a waveguide on which it is adjacent to be in optical communication, making it a grating coupler. Using a grating coupler between the deflection element and the substrate allows to provide high coupling efficiencies from the optical deflector into for example an embedded waveguide in the substrate.

In an embodiment the micro-optical device comprises at least one micro-optical interconnect component wherein at least a photodiode and/or a photodetector and/or a photosensitive material or layer, and/or a microlaser is arranged into and/or onto said substrate and being configured in optical communication with said reflective element. A microlaser may be chosen among one of: a VCSEL, a laser diode, a micro-LED, a SLED.

In a second aspect the invention is achieved by micro-optical system comprising at least one micro-optical device and at least one micro-optical interconnect component as described.

In an embodiment, the micro-optical system comprises at least two micro-optical devices that are arranged on a common platform. In an advantageous embodiment, the micro-optical system comprises at least two micro-optical interconnect components as described. In an embodiment of the micro-optical system, at least two micro-optical devices are connected by at least one of said optical alignment structures. In an embodiment micro-optical system comprises at least one micro-optical interconnect components as described and at least one micro-optical devices as described, both being interconnected mechanically by said optical alignment structures.

Arranging at least two optical interconnect components in a single optical system or combining different optical systems or different optical interconnects, preferably by using said alignment structure allows to provide a versality of photonic chip arrangements and assembly, in 2D or in 3D.

In a third aspect, the invention is also achieved by a method of fabrication of an array of micro-optical interconnect components as described. The fabrication is based on the realization on a single substrate, and comprises the steps of:
providing a substrate defining an array of first surfaces;
providing a mold, partially transparent for UV-light, comprising a structured surface having an array of forms configured to realize, by a replication step, an array of light deflecting elements and an array of alignment structures. Said mold comprising areas substantially transparent to UV light and other areas substantially opaque to UV light;
applying UV-curable material onto at least a predetermined portion of said mold comprising a structured surface or on at least a predetermined portion of said substrate;
aligning said structured surface of said mold onto a specific location of said predetermined array of first surfaces;
providing UV-light onto a UV curable material, through said mold, so as to cure said UV curable material selectively in areas substantially transparent to UV light and provide an array of light deflecting elements on an array of said first surfaces, said light deflecting elements having at least one curved surface and provide an array of optical alignment structures that are very precise and stable, each facing the first face of said light deflecting elements of the array of light deflecting elements;

The fabrication process of the invention allows to provide batch processed interconnect components that are cost efficient, allow a self-alignment of optical components to be interconnected and that have a high light coupling/deflection efficiency, preferably of more than 80% while allowing to have very low scattering of light due to the high smoothness of the realized surfaces and a broad wavelength range of operation.

### BRIEF DESCRIPTION OF THE DRAWINGS

Further details of the invention will appear more clearly upon reading the following description in reference to the appended figures:

FIGS. 1-2 illustrate typical optical interconnects of prior art showing out of plane (vertical) aligned fibers relative to a PIC optical platform;

FIG. 3 illustrates a cross section of a portion of a micro-optical interconnect according to the invention;

FIG. 4 illustrated a ray tracing in a cross section of a portion of a micro-optical refractive reflector according to the invention;

FIG. 5A-B illustrates a perspective view of a portion of a micro-optical interconnect component according to the invention;

FIG. 6 illustrates a top view of a horizontal section, orthogonal to the surface of the platform of a micro-optical interconnect component according to the invention; the position of a grating under a reflecting element is also illustrated;

FIG. 7 illustrates another top view of a horizontal section, orthogonal to the surface of the substrate of a micro-optical interconnect according to the invention;

FIG. 8 illustrates a view of a vertical section in a plane orthogonal to the surface of the substrate of a micro-optical interconnect according to the invention;

FIG. 9 illustrates a tapered waveguide grating coupler of the invention, that is situated between a substrate and the optical reflector of the interconnect component;
FIG. 10 illustrates an embodiment of fabrication steps to realize the micro-optical interconnect according to the invention;

FIG. 11-13 show realized structures of the interconnect of the invention.

FIG. 14 is a SEM picture of a micro-deflector of the invention, and shows a typical interconnect device used in a configuration o couple light provided by a fiber to a waveguide arranged on a substrate.

FIG. 15-17 show basic configurations of the interconnect component of the invention.

FIGS. 18- 22 illustrate examples of optical interconnect components, optical devices and optical systems according to the invention.

FIG. 23 Illustrates a finite element method computation of light propagation in the micro-optical deflector and focusing from an optical fiber in optical alignment structure towards the first surface.

### DETAILED DESCRIPTION AND EMBODIMENTS OF THE INVENTION

The present invention will be described with respect to particular embodiments and with reference to certain drawings, but the invention is not limited thereto. The drawings described are only schematic and are non-limiting. In the drawings, the size of some of the elements may be exaggerated and not drawn on scale for illustrative purposes. The dimensions and the relative dimensions do not correspond to actual reductions to the practice of the invention.

It is to be noticed that the term “comprising” in the description and the claims should not be interpreted as being restricted to the means listed thereafter, i.e. it does not exclude other elements.

Reference throughout the specification to “an embodiment” means that a particular feature, structure or characteristic described in relation with the embodiment is included in at least one embodiment of the invention. Thus, appearances of the wording “in an embodiment” or, “in a variant”, in various places throughout the description are not necessarily all referring to the same embodiment, but several. Furthermore, the particular features, structures or characteristics may be combined in any suitable manner, as would be apparent to a skilled person from this disclosure, in one or more embodiments. Similarly, various features of the invention are sometimes grouped together in a single embodiment, figure or description, for the purpose of making the disclosure easier to read and improving the understanding of one or more of the various inventive aspects. Furthermore, while some embodiments described hereafter include some, but not other features included in other embodiments, combinations of features if different embodiments are meant to be within the scope of the invention, and from different embodiments. For example, any of the claimed embodiments can be used in any combination. It is also understood that the invention may be practiced without some of the numerous specific details set forth. In other instances, not all structures are shown in detail in order not to obscure an understanding of the description and/or the figures.

The wording “cross section” in the document is defined as a horizontal cross section, meaning a cross section in an X-Y plane which is defined as a plane parallel to the plane of the substrate or optical platform 10. The wording “vertical” means here perpendicular to the substrate 10. A vertical cross section is a cross section in a plane that comprises the vertical axis Z that is defined orthogonal to the substrate. X-Z and Y-Z planes define vertical planes that are orthogonal to the substrate. Horizontal planes are X-Y planes that are parallel to the substrate. A radial direction means a direction defined in a horizontal cross section, so defined also in a horizontal plane. A lateral direction is defined in an X and/or Y direction in a horizontal plane. A width is defined as a width of a structure across a virtual line in a horizontal cross section. Thicknesses are defined herein as thicknesses in the vertical direction, i.e. in the direction of the Z-axis. The positive Z-direction is defined as the top direction. The bottom direction is opposite to the top direction.

As used herein a substrate may also be defined as a platform.

The term “Q-lens” used herein means a refractive micro-element that has the shape of a fraction of a microlens, for example the fraction of a spherical microlens, typically having the volume of ⅛^{th} or ¼^{th} of a spherical microlens.

Micro-reflective elements are defined here as any micro-optical structure or component that is realized between the output coupling surface of an optical microcomponent and an incoupling surface of an optical platform, substrate or PIC. Microcomponents are defined herein as components that either emit, transmit, deflect, focus or defocus, filter or detect light such as, without being limited: optical fibers, optical lenses, light emitters, light detectors, embedded waveguides, light filters. Micro-reflective elements are preferable reflective structures or elements but may be partially refractive elements and may be partially refractive and partially reflective or rely only on total internal single or multiple reflections (TIR). Reflective collimating surface, on the opposite to refractive or diffractive collimating surfaces are dispersion free, making them suitable to work over a broad spectral range without noticeable change of focusing quality or efficiency. They have been used in a huge variety of optical application but have been much less used at the microcomponent scale due to the difficulty of fabricating high-quality curved surfaces at this scale. As an example, ellipsoidal and parabolic shape, which allow to deflect and focus the light between respectively two points in space or to or from a point and a collimation axis are used extremely often at the macrometric scale but not at the micrometric scale. The optical interconnect of the invention may be configured for any wavelength of operating light of the microcomponents, e.g. of guided light by an optical waveguide such as an optical fiber.

The term “alignment structure” as used herein is defined broadly and means a mechanical structure or a plurality of structures that are suited to align or fix optical components which may by optical fibers, microlasers, microlenses, detectors or also to align and mounts optical interconnect components and devices together. In preferred embodiments optical components may be clipped mechanically in or onto the alignment structures but may also be glued or welded on them and may be used for accurate passive alignment before optical components gluing or welding or clipping.

An micro-optical interconnect component or interconnect element is defined as a platform on which optical elements, such as optical fibers, may be arranged.

A micro-optical device is a micro-optical component comprising optical elements, such as optical fibers. Optical fibers may be arrays of monomode or multimode fibers or multicore fibers.

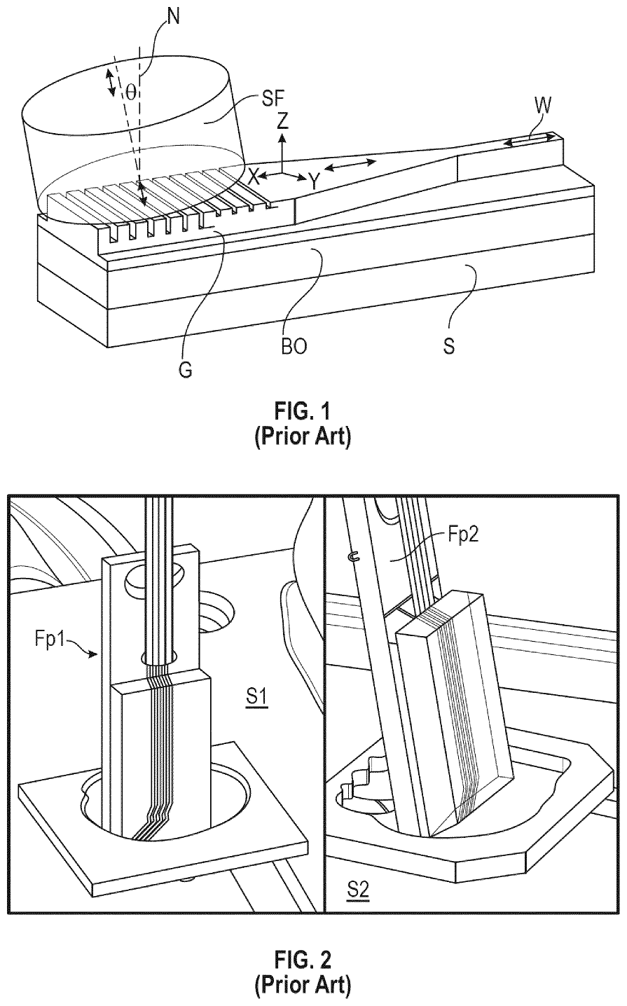

FIGS. 1-2 illustrate a typical optical coupling of fiber-waveguide coupling devices of prior art. Most of the solutions to couple an optical component such as an optical fiber to an optical platform or photonic chip relies on an arrangement wherein the optical axis is arranged at a high angle relative to the plane of the optical chip (out of plane). The reason is that it is difficult to couple light into a waveguide in arrangements wherein the emitted light beam, for example outcoupled from a fiber, and, for example, a waveguide is substantially parallel to the plane of said platform. i.e. making an angle smaller than 45° with the platform 10. The invention provides a solution to this type of typical problem and proposes a device that is not only compact, but that can be realized in large number in parallel on a wafer level, can offer self-alignment features and provide a cheap, reliable and optical efficient solution.

### I) Optical Interconnect Component 1

In a first aspect the invention relates to an optical interconnect component 1 comprising an optical platform comprising a substrate 10, defining a first substrate surface 12, to adapt optical structures and a second surface 14 opposite to said first surface 12. The platform comprising, arranged onto said first substrate surface 12, at least one optical alignment structure 4.

Said at least one optical alignment structure 4 is adapted to fix an optical component and/or arranged as alignment structure to adapt another interconnect component 1, defined also as interconnect element.

The substrate 10 comprises a light deflecting element 30 arranged on said first surface 12 and being made of a material having a refractive index higher than 1.

The light deflecting element 30 comprises a first face, facing said optical alignment structure 4, and a second face facing said substrate to a second side, said first and said second side being connected by a curved surface being an optically reflecting surface.

The light deflecting element 30 has a shape so that an incident light beam onto said first 30′ or second surface 30″ is deflected by an angle between 60° and 120°, said incident light beam may be provided from the outside or the inside of said substrate 10.

In a preferred embodiment the first surface 30′ and the second surface 30″ of the micro-deflector are in orthogonal planes, said second surface 30″ being preferably orthogonal to the first surface 12 of the substrate 10.

In an embodiment the light deflecting element 30 is configured to reflect more than 80%, preferably more of light provided from said first face to said second surface or vice versa.

In an embodiment said light deflecting element 30 is configured to reflect more than 80% of light provided from said first face to said second surface or vice versa and this over a spectral width greater than 250 nm, preferably greater than 500 nm.

In an embodiment said optical alignment structure is arranged to align and hold in position a waveguide 20. IN an embodiment an alignement structure may be configured to align and fix more than 1 optical waveguide that may be arranged in a horizontal plane and/or a vertical plane.

In an embodiment said waveguide 20 is one of: an optical fiber, an optical fiber bundle or a multicore fiber.

In an embodiment said curved surface has an aspherical shape, defined in at least one of its cross-section planes.

In an embodiment said light deflecting element 30 is configured to focus an incident parallel beam on its first or second surface into a spot having a largest dimension of less than 50 μm, preferably less than 20 μm, more preferably less than 10 μm at said second-30″, respectively first surface 30′. The first face 30′ is to the side of the substrate 10 and the second face 30″ is facing the alignment structure 4 or structures 42, 44.

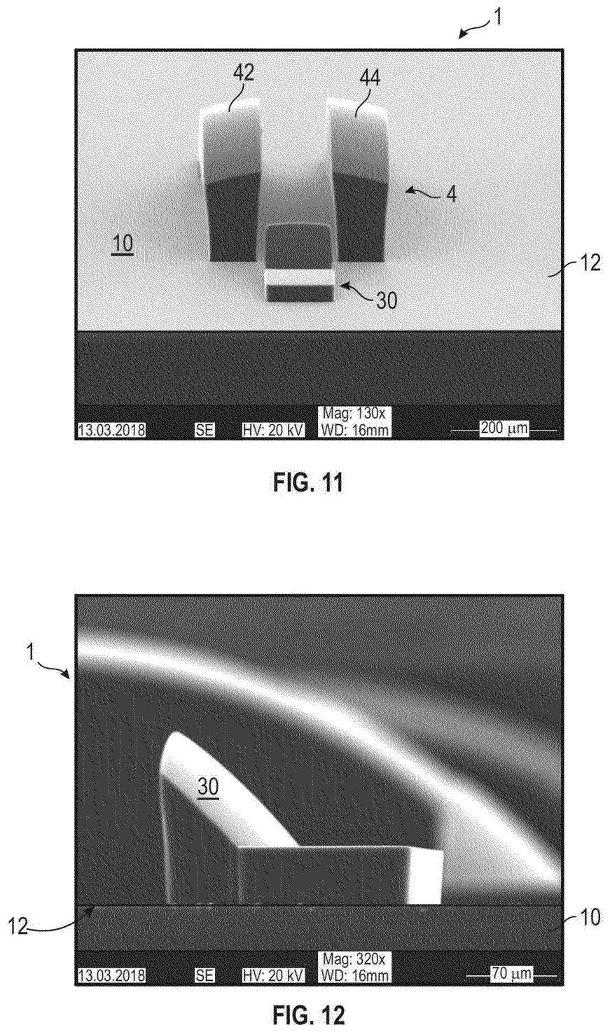

In an embodiment, illustrated in for example FIGS. 11, 12, 18, said optical component is configured to fix an optical waveguide 20 and the alignment structure 4 is a waveguide alignment structure comprising at least two opposite walls 42, 44 to fix at least a portion of a length (L) of said waveguide 20 between said walls 42, 44, said waveguide alignment structure 4 facing said light deflecting element 30, to the side opposite to said curved reflecting surface.

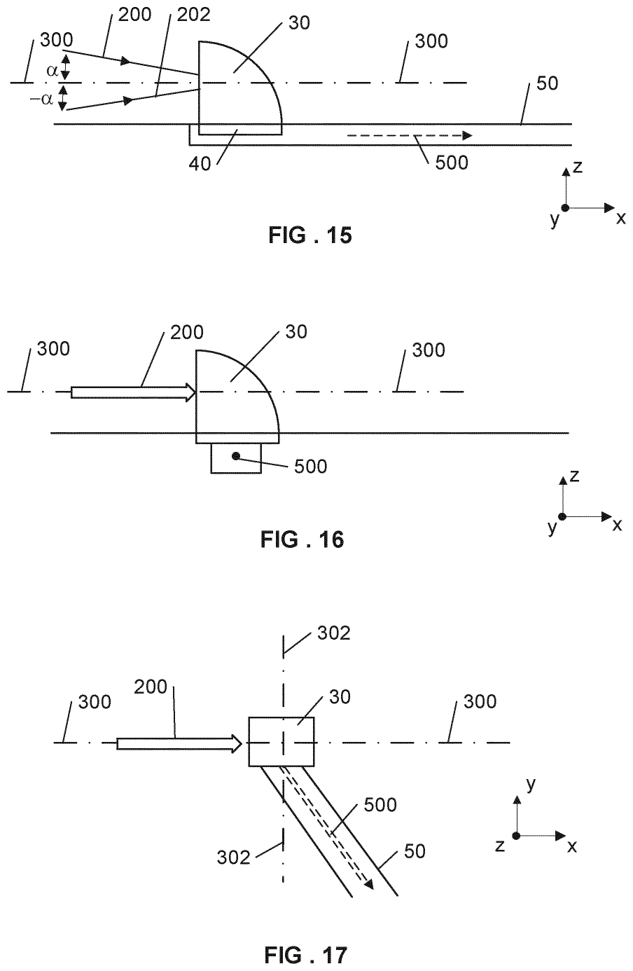

FIGS. 15, 16 illustrate typical configurations of the coupling of light, by the microdeflector 30 of the invention from an incident light beam to a waveguide 500 embedded in a substrate 10. In FIG. 15 the waveguide is in the same direction of the axis 300 of the infalling light beam onto the deflector 30 and in FIG. 16 the waveguide is at 90° to the incident light beam. Typical incident angles α (relative to the substrate 10) of incident light 200, 202 on the deflector element 30 is between +−30°, i.e. defined as substantially parallel to said first substrate surface 12.

FIG. 17 illustrates how light may be incoupled in a waveguide 50 so that the guided wave 500 progresses at a predetermined angle to the incident light or to an defined axis 302 of the micro-deflector 30.

In embodiments an optical waveguide 20 may be:
a flat optical waveguide,
a multimode or monomode waveguide,
an optical fiber,
a fiber bundle, preferably a flat fiber ribbon comprising at least two optical fibers.

It is understood that the micro-optical interconnect component 1 may be configured to align, attach and fix other components at any place such as detectors, transducers, MEMS structures or sensors, or active alignment structures.

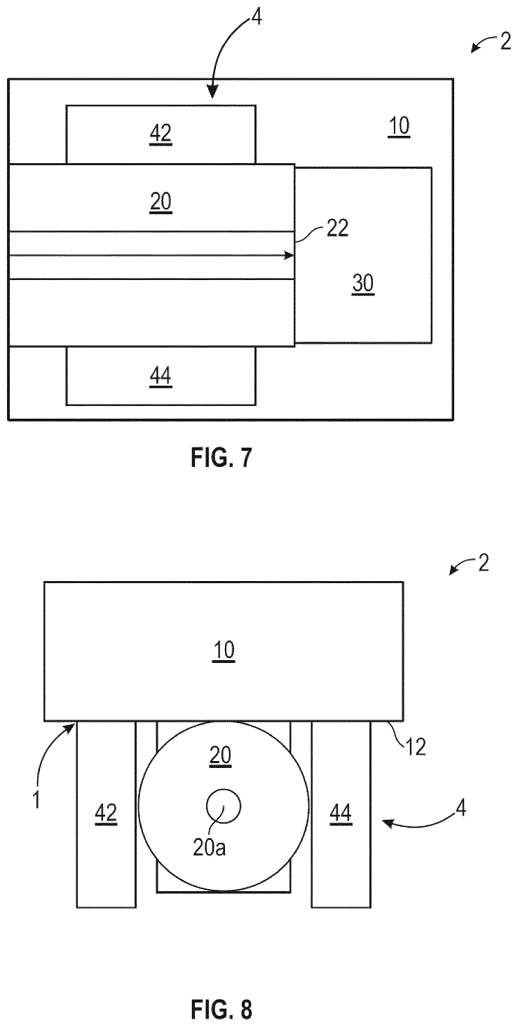

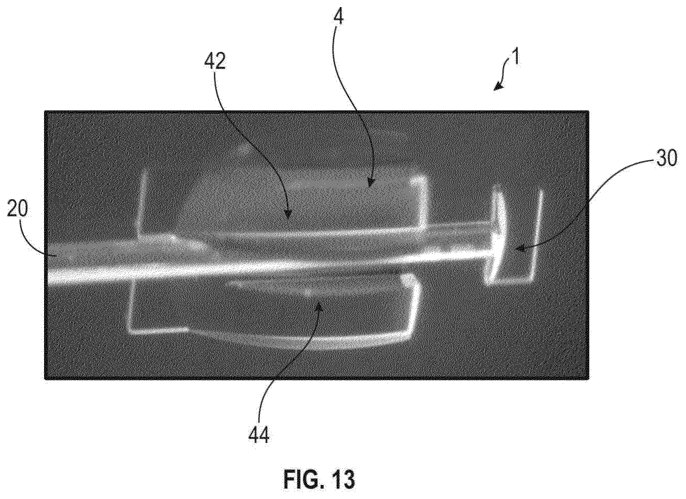

In a preferred embodiment the substrate 10 comprises a fiber-alignment structure 42, 44 that is monolithically integrated in said substrate 10, illustrated in FIGS. 7, 8, 13. The alignment structure 4 consists preferably of at least two opposite walls between which at least a portion of said length is fixed between said walls. Said opposite walls are understood as two microstructures having each a facet substantially facing each other, said facet being not necessarily perfectly planar nor perfectly perpendicular to the surface of the platform of the micro-optical interconnect. Said walls themselves can have various geometries extending beyond this facet. The wall's typical height, as defined perpendicular to the platform, are typically similar to the fiber outer diameter on the platform (the fiber height when locally in contact and parallel to the platform), may be shallower or deeper than the fiber outer diameter for assembly and locking purpose or other design constraints.

As explained further, such alignment structures 42, 44 may be integrated in said platform or may be built on said platform. A plurality of alignment structures may be provided such as an array of couples of walls that may be arranged beside a V-groove arranged in said platform 10.

In a preferred embodiment, a light deflecting element is arranged on a grating coupler 39,40, arranged on said substrate 10, and faces a light emitting surface of an optical component, so that at least a portion of light provided by said outcoupling end is deflected to said grating coupler and incoupled into said waveguide.

In a variant, the grating coupler 4 may be an active grating 39, being a grating that may be addressed by electric means, or the grating may be a passive grating.

The proposed compact interconnect components 1 are preferably based on total internal reflection (TIR), but metal or dielectric layers may be used as the reflective layer to improve the reflectivity, especially on portion of the curved surface where TIR conditions are not met.

The reflective surface of the proposed micro-optical interconnect is preferably aspherically curved, at least in one cross section plane of the reflector 30. The radius of curvature, conicity or other aspherical shape parameters can be controlled during the fabrication process of the structured surface of the master used for the fabrication of the mold used for the fabrication of the interconnect. The curved surface allows for a focusing of the incoming light on the substrate. This is illustrated in FIG. 23 that shows a typical ray-tracing in a micro-deflector 30 of the invention. The curved surface of the deflector element 30 may also allow for spot-size conversion between the optical beams from the grating coupler 40 (or other optical elements in different variation) on the substrate 30 to the in-coupled optical fiber in addition to optical beam deflection. Well-known and preferred curved surfaces are portions of ellipsoid and especially portions of prolate spheroids for point to point conversion and paraboloid surface for axial to focus conversion. In these cases, the ellipsoid/prolate spheroid or paraboloid can be designed in straightforwardly, as an example the foci of the prolate spheroids being the two points for point to point conversion, with eventual compensation of their location for refraction in case of change of refractive index.

In variants, the proposed compact folded interconnects may comprise mirror coatings, reflective structures or a combination of TIR and reflection. Reflections may be multiple reflections realized inside the reflectors 30 such TIR reflections as provided by for example reflectors 30 that are configured in the shape of a periscope or other. Optical reflectors 30 may comprise portions that split a part of the incoupled beam into different parts, which can be useful for intensity referencing purposes.

In the design of an example of micro-optical interconnects 1 for light redirection from a standard glass fiber, several constraints and requirements were taken into account: The geometry of the micro-optical structures was covering all of the most common telecom and data-com wavelengths thanks to the reflective design being intrinsically achromatic. This example was modelled to be compatible both with multimode fibers (MMFs G50, operating at 850 nm with a core size of 50 μm and a numerical aperture NA=0.20) and with single mode fibers (SMFs E9, operating at 1300 nm or 1550 nm with a core size of 9 μm and a numerical aperture NA=0.13). Furthermore, the height of the light deflector elements is made compatible with the location and size of the core of standard fibers.

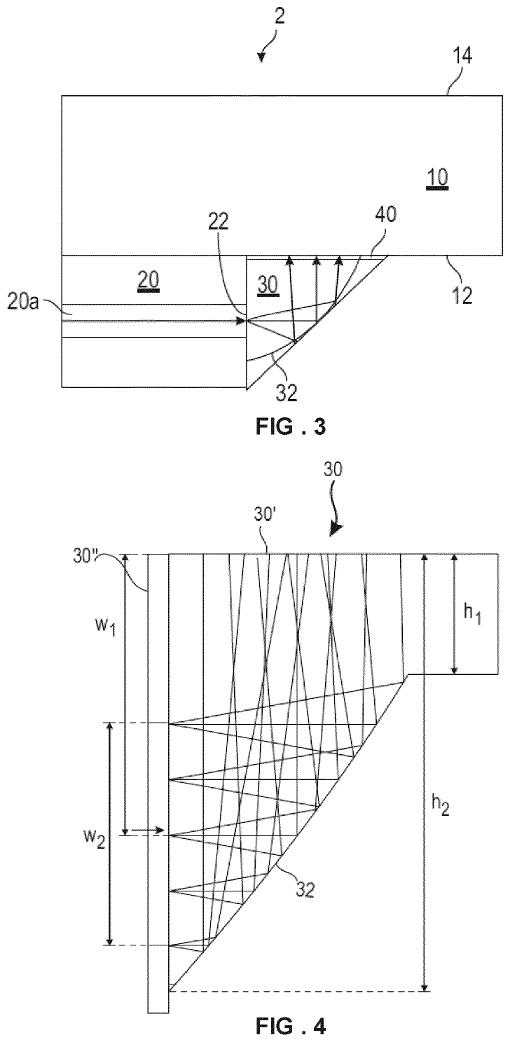

The beam divergence at the exit of the glass fiber must comply with the TIR requirements at the curved surface and adapted to the location of the optical structure on the substrate (e.g. grating coupler). In the case of micro-lenses that have the shape of a portion of a sphere, also defined as quarter-lenses or Q-lenses, in order to satisfy the above requirements, the curved surfaces have been made micro-lenses having preferably radii between 600 μm and 2000 μm. Preferably said Q-lenses have the shape and the volume of a quarter/piece of a ball-shaped microlens which may be a sphere but may also have another shape having at least one elliptical cross-section. Typical reflecting micro-optical elements 1 are sketched in FIG. 3-4.

The micro-reflectors may comprise a socket 31 as illustrated in FIGS. 4, 5A, 5B, 6, 12, 14.

The main geometrical constrains for the example with an MMF G50 fiber as input source are the following:
h1<27.5 μm (residual height of the socket 31 of the reflector 30)
h2>90 μm (structure height)
w1=62.5 μm (fiber core 20a position relative to the first substrate surface 12)
w2=50 μm (fiber core 20a size)

The main geometrical constrains for the example with an SMF E9 fiber as input source are the following:
h1<40.5 μm (residual height of socket 31)
h2>70 μm (structure height)
w1=62.5 μm (fiber core 20a position relative to the first substrate surface 12)
w2=9 μm (fiber core 20a size)

In an embodiment, said light deflecting element 30 is partially a refractive element, such as a fraction of a plastic, sol-gel or glass lens or any transparent material acting as a deflecting element.

In an embodiment, said reflective element, which may be a partially refractive element used to perform total internal reflection, has a curved reflective surface, of which at least one cross section may have a polynomial shape. In preferred embodiments he curved surface is spherical and may be, on at least one cross section be aspherical or ellipsoidal.

In variants the X-Z cross section, the curvature may be ellipsoidal (preferably a prolate spheroid or a paraboloid) or have a top-chopped off section of a sphere in the Z-direction. The structured surface of the master used for the fabrication of the mold used for the fabrication of the interconnect light deflecting elements is preferably made from a mold used for microlens fabrication allowing high quality curve surface fabrication in large arrays, such as a photoresist reflow process, eventually including a post-processing step such as a plasma reactive ion etching with different photo-resist and substrate selective to obtain various aspherical shapes. The fabrication process allows for elliptical radiuses of curvature ranging from 2 μm to more than 2000 μm. In addition, the process allows for the independent control over the height of the sphere slice and the radius of the curvature while providing very high homogeneity over full wafer, very low surface roughness, typically below 10 nm RMS, commonly below 5 nm RMS.

In a preferred embodiment said refractive element 30 has the form of a portion of a sphere, for example a quarter/piece of a sphere or a cylinder which is defined as a Q-lens. Using a cylindrical curved surface for the deflector 30 allows beam collimation only in a single plane. However, this can be sufficient for some interconnection applications according to embodiments od the invention and has the advantage of being compatible with the fabrication of arrays of interconnect with high density as the curved surface of a single cylindrical microlens can be used as the curved surfaces of multiple light deflecting elements.

FIG. 3-6 illustrates a device 2 comprising micro-optical interconnect element directly replicated on a glass wafer by UV casting. The process of UV casting, part of the UV-nano-imprint lithography processed (UV-NIL), sometimes call UV-embossing, allows the high-fidelity replication of micrometric to millimetric components with nanometric fidelity in some cases. The publication “Replication technology for optical microsystems”, Gale and all, Optics and Lasers in Engineering 43 (2005) 373-386 describes examples of such processed and is included here in its entirety. FIG. 3 and FIG. 4 shows a typical ray trace within the micro-optical element 1 and main geometrical constrains in the case of a G50 fiber approach.

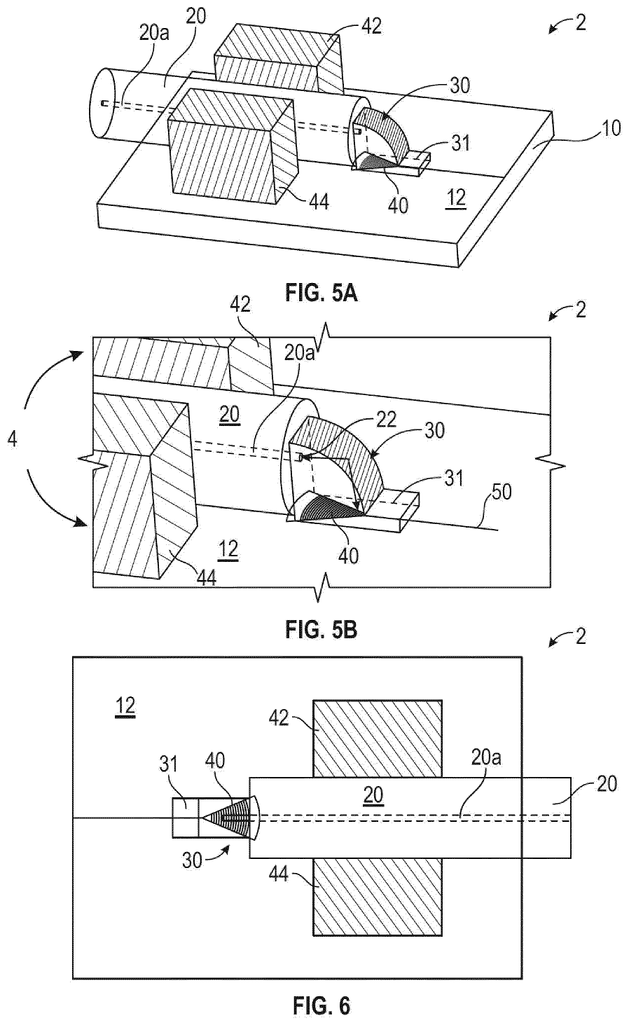

While processing the micro-optical structures, specifically Q-lenses, optical-alignment structures can be replicated for passive alignment of microcomponent: see FIG. 5-8 for example with fiber optical alignment structures.

It is understood that a wide variety of shapes and materials can be used for the optical alignment structures.

In embodiments as illustrated further in the fabrication method section, the fiber alignment structures are made during the same fabrication step as the light deflecting elements, but this must not be so necessarily. The alignment structures can be formed as vertical walls precisely aligning a fiber to the optical axis of the reflector. These walls can incorporate funnel shape as viewed from the top to ease fiber insertion

In variants, fiber alignment structures 4 could be formed as a plurality of tubes with cones or as conical pillar structures

In variants, fiber alignment structures 4 could be incorporated into the platforms beforehand (i.e. as V-grooves), i.e. before the process steps of the microdeflector 30. Also, a combination of structures incorporated into the platforms and material added on the platform by UV-casting are also possible.

In variants said optical substrate 10 is made at least partially of one of: silicon or Si3N4 or LiNbO3 or other photonics materials (such as InP, GaP, GaAs), or glass.

In an embodiment, a fiber-alignment structure 42, 44 may be made out of a polymer, or glass, or silicon, or sol-gel or a uv-curable resin (or other transparent materials possibly covered with a reflective layer, or exhibiting at its interface with air total internal reflection) or a combination of them.

In a preferred embodiment said reflective element 30 is made out of a polymer, or glass, or silicon, or sol-gel or a UV-curable resin (or other transparent materials) or a combination of them. In cases where it is preferable to add a reflection coating on the refraction element, said refraction element possibly working by refraction, reflection or the combination of both, the reflection coating can be realized locally on the surface of the refraction element requiring this reflection coating. For example, a wafer level vacuum coating using a shadow mask, the printing of a metallic ink, possibly followed by a sintering step, can be used to create local reflection coating on a portion of multiple optical interconnects in parallel or serial processes. This can improve the beam transport efficiency in cases where total internal reflection is not possible for the whole optical beam.

In an embodiment, a grating coupler 40 is arranged between the substrate surface 12 and the microdeflector 30. Such grating coupler 40 is made at least partially of Si₃N₄ or Silicon or LiNbO₃ or other photonics materials (such as InP, GaP, GaAs etc.)

In an embodiment said grating coupler 40 is a tapered grating coupler. FIG. 9 shows a realized tapered grating coupler

Typical dimensions of tapered gratings 40 are:
Tapering length ˜10 μm
Widths of the strips of the grating 40˜1 μm
Gap between stripes of the grating 40˜1 μm

The dimensions of the grating 40 may vary based on the wavelength and the material and its refractive index.

For example, for an implemented configuration, the following dimensions where used for the experimental demonstration of the concept for the wavelength of 1550 nm and the incident angle of 8°:
Tapering length=10 μm
Widths of the strips of the grating 40=500 nm
Gap between stripes of the grating 40=620 nm
Number of stripes of the grating 40=30
Tapering angle of the grating 40=30°
Grating type=Uniform grating (no-appodization)

The grating can be circular shape (in the form of slice of a circle) or linear or have more complicated geometries.

The grating 40 can be uniform or chirped (linear or non-linear chirped) or appodized or may be constituted as a resonating waveguide also defined as zero-order filter (ZOF) that is in optical communication with the waveguide.

In variants, the grating coupler 40 may be realized by other optical couplers such as plasmonic couplers, combined plasmonic/dielectric couplers, electro-active couplers, dielectric metasurfaces couplers, plasmonic metasurfaces couplers or hybrid plasmonic/dielectric metasurfaces or reconfigurable/tunable MEMS gratings or any combination thereof. Such variants are referred to generically as grating couplers as, while having different physical behavior and optical functionality, they are essentially diffracting light wavefronts like gratings couplers are.

It is generally understood that the micro-reflector 30 may be an array of micro-reflectors that may comprise different shaped reflectors 30. In such a case the optical axis of the reflected beams from the elements of an array of reflectors 30 must not be necessarily parallel. It is also understood that at least one of the reflectors may direct light into a second grating and into a second waveguide that is arranged on a second platform that may be substantially parallel to a first platform.

### II) Optical Device (2) and Optical Systems (2′)

In a second aspect the invention concerns an interconnect device 2 comprising a first optical waveguide 20 and said optical interconnect element 1.

FIGS. 5-8, 13, 14 illustrates an interconnect device 2 comprising an optical fiber arranged in the alignment structures 42, 44.

FIG. 20 illustrates device 2 based on an interconnect 1 that has fiber alignment structures 4.

FIG. 20 illustrates a device 2 that is arranged to couple light from an optical fiber 20 into a waveguide and so that the incoupled light is guided in the opposite direction than the infalling light beam onto the microdeflector 30.

In an embodiment the micro-optical device 2 comprises the micro-optical interconnect component 1 as described and at least a photodiode and/or a photodetector and/or a photosensitive material or layer, and/or a microlaser (FIG. 22) may be arranged into and/or onto said substrate 10, the mentioned components being configured in optical communication with said reflective element 30. In an embodiment said microlaser is chosen among one of: a VCSEL, a laser diode, a micro-LED, a SLED.

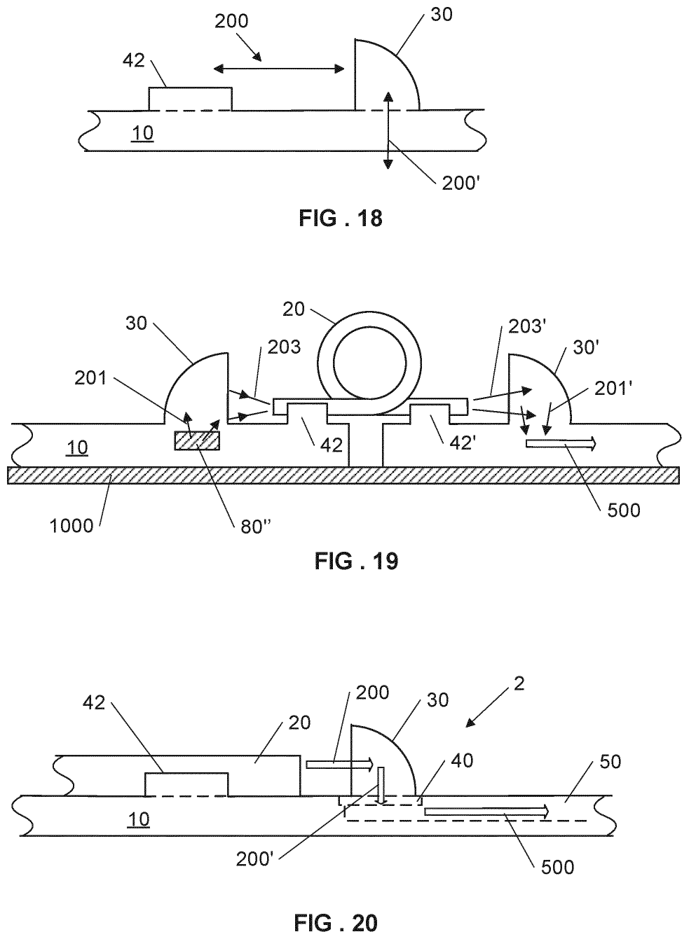

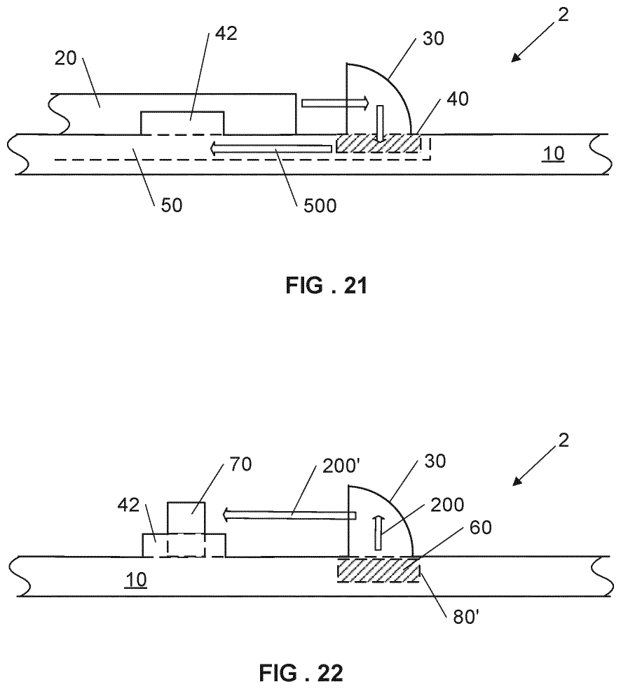

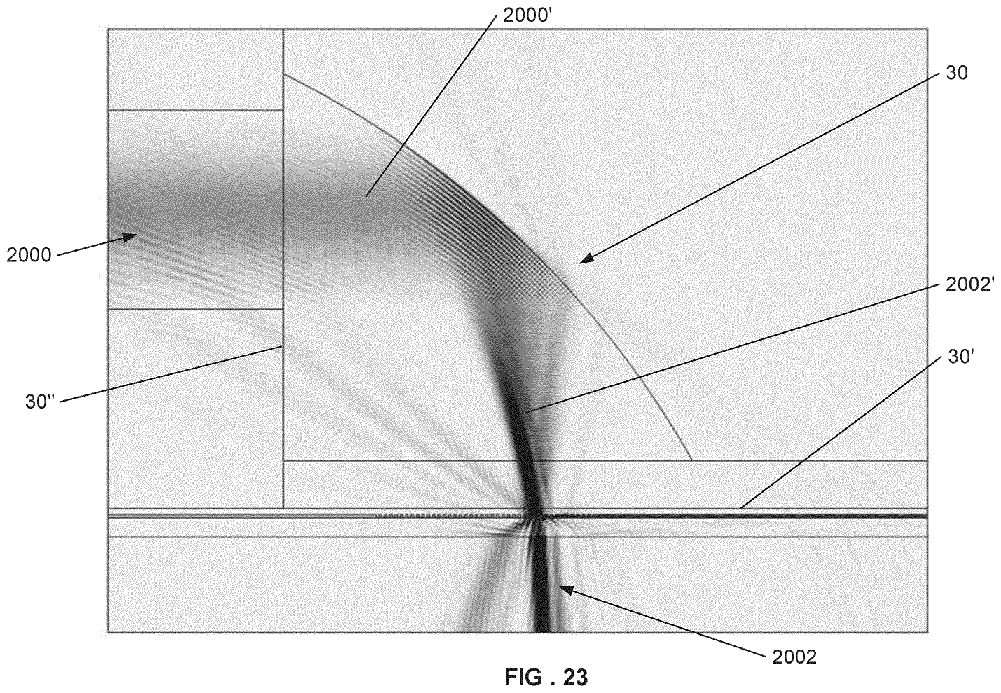

The invention relates also to a micro-optical system 2′ comprising at least one micro-optical device 2 as described and comprising at least one micro-optical interconnect component 1 as described and illustrated in FIG. 18. FIG. 19 illustrates an example of two micro-optical device 2 that are optically connected by an optical fiber, having on each micro-optical device 2 a length of fiber 20 that is fixed on the alignment structure of the micro-optical device.

In an embodiment micro-optical system 2′ comprises at least two micro-optical devices 2 that are arranged on a common platform 1000 (FIG. 19).

In an embodiment the micro-optical system 2′ comprises at least two micro-optical interconnect components 1 (FIG. 19). The at least two micro-optical interconnect components 1 may be arranged on opposite sides of a common platform (not illustrated).

In an embodiment the micro-optical system 2′ comprises at least two micro-optical devices are connected by said optical alignment structure 4.

The invention relates also to a micro-optical system 2′ comprising at least one micro-optical interconnect components 1 and at least one micro-optical devices 2 are interconnected mechanically by said optical alignment structures 4.

In other variants, a VCSEL, or LED or any other light emitting component that is emitting light in near vertical direction and may be located in the substrate material 10, at least partially below said first surface. In other variants, a photodetector surface or any other photosensitive surface that requires normal light incident to detect light intensity can be located at least partially below said first surface.

For example, a beam shaping element, such as a diffractive element or structure, may be realized between said fiber outcoupling end 22 and the reflector 30. Also, a zero-order filter element may be integrated between said grating 40 and said reflector element 30 and said optical platform 10.

In variants the device 2 may be adapted to incouple light provided by a flat bundle of fibers or fiber arrays. In this case the reflector element 30 may have the shape of a portion of a cylinder or several individual reflectors with defined spacing. Such arrays of micro-optical interconnects may be especially useful to manufacture photonic integrated circuits (PICs) providing optical fiber switching matrices, parallel optical fiber re-amplification of parallel data processing from multiple optical connections.

In other variants the curved surface of said reflecting element may be an aspherical surface. In still other variants the reflector element may be made by two different layers that may have a different refractive index or that may be colored so as to act as a reflecting color filter. In embodiments structures and/or layers may be provided on the reflecting surface of the reflecting element 30. Said layer may be a reflecting layer such as a metallic layer.

In exemplary configurations, a device 2 or system 2′ may comprise also reflective components without fiber for direct irradiation of the light into the free-space. This can be used for in combination of phase arrays (e.g. electro-optical phase shifters) for beams steering in LIDARs or for video projection. Also, a mirror can be used to couple light from or to other optical elements such as VCSELs and photo-detectors and photo-cell to or from optical fibers, or to couple light from VCSEL (which is easier to make than other chip scale lasers) back to the chip.

### III) Method of Fabrication

The invention proposes also a method of fabrication of the micro-optical interconnect.

One of the most cost-effective fabrication technologies for volume production of micro-optical components is based on wafer-scale UV replication into chemically stable polymers using standard semiconductor equipment [7].

The method of the invention comprises the following steps:
Step A: the micro-optical structures are originated and a master is fabricated, which is then used to produce the replication tool, i.e. the mold. Various master origination (fabrication) techniques are possible depending of the mold geometries, the structured surface, to be obtained, as known from the man skilled in the art. In an example, for the mastering of standard micro-lenses (i.e. Q-lenses), photolithography and a reflow process are applied [8]. In another example, laser writing plus chemical post polishing can be used [9]. Other techniques include, but are not limited to, grey-scale photolithography, diamond turning and micromachining, multi-photon polymerization, etching, wet etching or dry etching such as reactive ion etching, micro-additive manufacturing or a combination thereof. Additionally, the mold contains areas substantially transparent to UV light, having a transmission of at least 30%, preferably more than 50% in a specified UV range, and areas substantially opaque to UV light, blocking at least 90% of the specified UV range. This can be formed for example by a thin patterned chromium layer on a glass or fused silica substrate. The structured surface can be formed on the mold by doing a UV-casting replication from the master to have its complementary shape, or from a cast of the master to have the same polarity, by UV exposure through the substantially transparent areas, by full face UV illumination or using another masking of UV light. UV-light for UV-casting processes are defined broadly as ultraviolet light as well as visible but violet light that can be used to excite photoinitiators, light having a peak wavelength shorter than 450 nm in air.
Step B: the micro-optical elements are replicated into a UV curable material using the fabricated mold. A UV-curable material is provided on at least a portion of the mold or on at least a portion of the substrate. The mold is aligned to the substrate over multiple axis, typically on 6 axis for rotational and location alignment. UV light is shouted to the mold and is at least partially transmitted to the UV-curable material in areas substantially transparent to UV-light, initiating a cross-linking or hardening process. Preferably a development step follows the UV-shouting and a demolding to remove uncured material. In particular, for the UV casting process, a modified MA6 mask-aligner may be used, enabling the replication of micro-optical structures at wafer-level with a precise control of the lateral alignment (below +/−1 μm) and of the height (+/−1 μm) as well as good rotational and tilt alignment of the replicated elements. A residual layer (h1 in FIG. 4) both defines and limits precisely the achievable height.

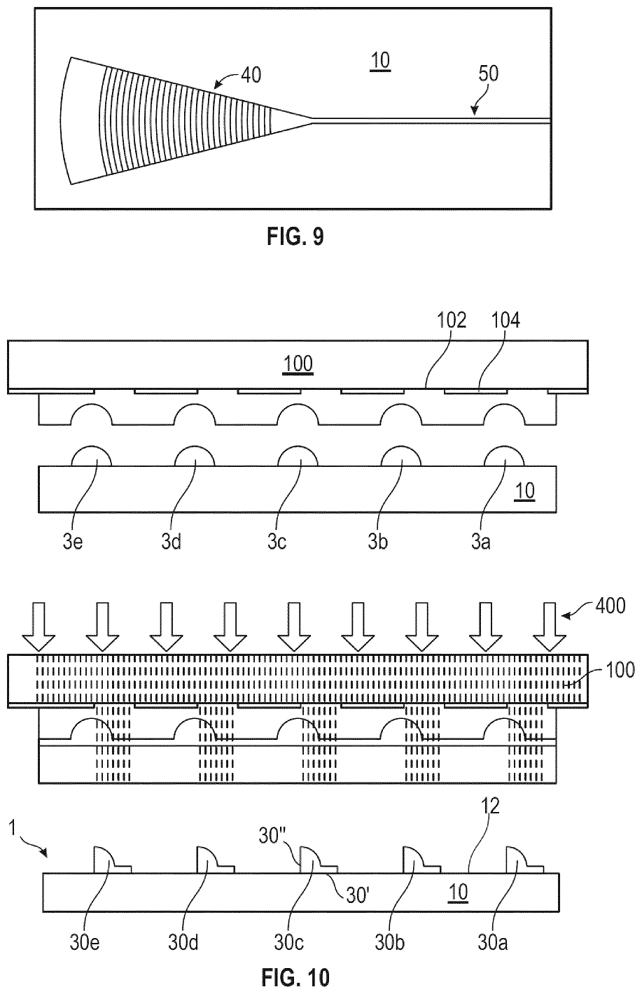

As for the replication of the micro-reflectors 30 together with the self-alignment structures 4, UV exposure is done through a specifically designed photomask that defines the final shape of the replicated structures on the glass wafer (FIG. 10, 18).

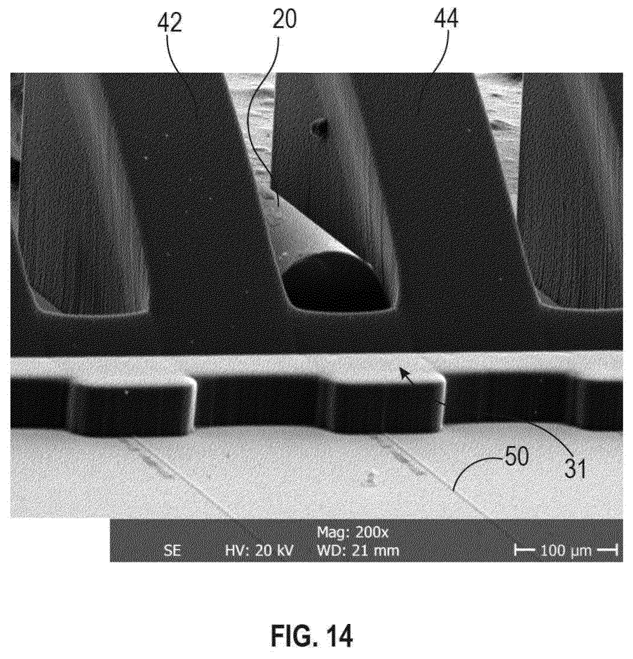

A SEM picture of a typical optical interconnect element 1 that comprises a Q-lens 30 having a first surface 30′ and a second surface 30″, and self-alignment structures 4 is shown in FIG. 11-14. FIG. 14 shows the back-side 32 of the microdeflector 30 and its residual back microplateform 31.

In an embodiment, the method of fabrication of the micro-optical interconnect comprising the steps (C-I) of:
C: providing a substrate 10 defining a first surface 12;
D: realizing on said first surface 12 a grating coupler 40;
E: providing a mold 100, transparent for UV-light, comprising a structured surface having a form configured to realize, by a replication step, a deflecting element and an alignment structure comprising at least two walls;
F: applying UV-curable material 3a-3e onto a predetermined portion of said substrate 10 comprising at least said grating coupler; FIG. 10 illustrates some portions of said UV-curable material which can have different shapes and thicknesses depending on the desired shape of the reflectors and the alignment structures
G: adapting said structured surface onto said predetermined portion;
H: providing UV-light 200 onto said UV-curable material, through said mold, so as to cure said UV-curable material selectively and provide a deflecting element and an alignment structure comprising at least two walls onto said first surface;
In an embodiment an interconnect device 2 is realized and comprises a step I of:
I: providing an optical fiber 20 and arrange the optical fiber so that it becomes aligned and fixed between said walls 42, 44 and so that at least a portion of the length of said optical fiber 20 is substantially parallel to said first surface 12.

FIG. 10 illustrates an embodiment of the method in which UV exposure is performed through a mold 100 including a patterned UV-blocking layer, a photomask, to define the final shape of the micro-deflectors 30a-30e together with self-alignment structures 42, 44.

In embodiments the alignment structures 42, 44 may be realized in a separate fabrication step than the step to produce the reflectors 30, 30a-30e.

It is understood that the platform may be made of a semiconductor material such as Si or Ge or may be a hybrid platform comprising at least a glass or plastic layer arranged on a metal, dielectric or semiconductor layer. For example, the optical coupler 1 of the invention may be realized on a glass layer that is present on top of a silicon mother board or platform. It is understood that silicon microstructures may be provided for example as the basis of the fiber alignment structures. For example, at least a portion of the fiber alignment structures may be made in Si and a glass or polymer layer may be arranged on the platform so that at least a portion of the alignment structures are protruding from the surface of glass or polymer layer.

Non-exhaustive list of variants of the micro-optical interconnects 1 are described hereafter:
The micro-optical interconnect component 1 can be designed to fix optical fiber on one side of a substrate and the waveguide and grating coupler on another side of this substrate or embedded inside this substrate.
The micro-optical interconnect 1 component can be designed to fix an optical fiber on one side of a first substrate and the waveguide and grating coupler on another substrate interface which is monolithically integrated with said first substrate.
The micro-optical interconnect component 1 can be designed to provide Wavelength Division Multiplexing (WDM) by providing multiple waveguide and grating coupler stacked on top of each other, each grating being optimize to couple in its adjacent waveguide a specific wavelength range portion.
The micro-optical interconnect component 1 can be designed to provide polarization multiplexing by providing at least two waveguides and grating couplers, each being polarization sensitive and having different polarization-dependent incoupling efficiencies.
The micro-optical interconnect component 1 can be arranged to comprise an optical deflecting element 30 placed at the opposite side of said fiber with respect to the waveguide and grating coupler, said reflector allowing a higher efficiency of the interconnection, especially on the waveguide to grating coupler to optical fiber direction. The reflector may comprise a metallic reflecting layer, a distributed Bragg grating or a resonant diffractive reflector.
The micro-optical interconnect component 1 can be arranged to comprise an absorber placed at the opposite side of said fiber with respect to the waveguide and grating coupler, said reflector blocking light provided by the optical fiber of by the waveguide to propagate/be scattered/leak to other parts of said platform.

The substrate 10 of the device of the invention could be but not limited to standard substrates such as Si, Glass, Fused Silica, Quartz, GaAs, InP etc. In embodiments, gratings 40 may be realized on thin films. “Optical thin film” herein refers to the thin film deposited on the substrate or of other films on top of the substrate and is used to fabricate the photonic integrated circuit such as waveguide and grating coupler. Standard thin films consist of but not limited to Si, Si3N4, SiO2, SOI, LiNbO3, LNOI, InP, GaP, GaN, GaAs, AlGaAs.

An optical thin film may be arranged in a way that has the highest index when sandwiched between two layers. For example, Si₃N₄ cannot be directly used on top of Silicon and a SiO2 film has to be deposited before deposition of Si₃N₄ layer (the same is valid for LiNbO₃)

Description of a Preferred Process Flow:

An optical thin film may be deposited on top of the substrate either by LPCVD, PECVD or other deposition techniques such as epitaxy, ALD etc. or by oxidation or top surface or by smart cut thin-film bonding (depends on the substrate and thin film material).

The optical circuit (including the waveguide and the grating coupler) is patterned into a resist using lithography (UV lithography or e-beam lithography). Patterns are transferred into the optical thin film via etching (Wet etching, Reactive ion etching (RIE) or ion milling depending on the material for the optical thin film).

After stripping the resist, a protective layer may or may not be deposited on top of the optical circuit. An example of such protective layer could be high or low temperature oxide, TOES or other thin films.

The design for the grating coupler may or may not including chirping of the grating. The chirp can be linear or non-linear (e.g. geometrical chirp) and is used for better mode matching between the reflected light of coming out of the fiber and the mode coming from the grating to achieve maximum coupling efficiency.

It is generally understood that reflectors could be made of a semiconductor (Germanium or Silicon for example) on a separate chip and the wafer bond on top of an optical circuit.

### IV) Exemplary Realization of a Micro-Optical Interconnect 1 of the Invention

A compact 90° optical interconnect 1 has been realized according to the present invention and is illustrated in FIGS. 11-13.

The interconnect element 1 in FIGS. 11-13 is based either on a Q-lens (i.e. a quarter of a sphere lens) or a 45° prism using TIR. Fabricated by UV wafer-scale replication, these micro-optical elements can reach excess losses as low as 0.35 dB. The beam profile measured along the propagation axis clearly shows both the quality of the replicated TIR surfaces and the precision of the deflection angle, thus proving that the used wafer-scale replication process can be implemented for industrial volume production without degrading the optical performance of the fabricated structures. Completed by the imprint of fiber self-alignment structures 42, 44, this solution facilitates considerably chip integration and connection of electro-optical components (such as LED, VCSELs, Photodetectors, PICs etc.) to standard glass fibers.

In order to compare the optical performances of the Q-lens solution with respect to the 45° prisms, optical losses were measured with a multi-fiber (E9 & G50) and multi wavelength (850, 1310 & 1550 nm) light source and an InGaAs detector.

In Table 1 hereunder, optical losses of the replicated 45° prisms and Q-lenses with 600 and 780 μm curvature radii are presented.

TABLE 1
optical losses

| Devices | SM loss [dB] | MM loss [dB] |
|---|---|---|
| 45° Prism | 0.35 | 0.42 |
| Q-lens 600 | 0.42 | 0.48 |
| Q-lens 780 | 0.36 | 0.38 |

In order to assess the optical quality of the replicated surfaces with respect to surface roughness, as well as the angle and the curvature precision for the 45° prisms and the Q-lenses, respectively, the horizontal (x-axis) beam profile was measured using a 200 μm diameter fiber detector at different positions along the beam propagation axis z. The results obtained for a Q-lens with a 750 μm radius and a multimode G50 input fiber placed between the self-alignment structures 42, 44 are shown in FIG. 12. On the one hand, the measured optical profile agrees very well with the predicted theoretical curves. On the other hand, the measured transmission losses are very low. Both results clearly prove the quality of the replicated TIR surfaces. Furthermore, the experimental curves in FIG. 12 clearly show the precision of the 90° deflection, as no beam displacement was observed from the theoretical center. It is highlighted that the Q-lenses provide the best optical beam profile performances with negligible losses.

The micro-optical interconnect described of the present invention can be designed to operate with different fiber types and fiber with different core dimensions, outer dimensions and numerical apertures. As example, single mode and multimode fibers can be used in the present invention with numerical aperture between 0.05 and 0.5. Multicore fibers can also be interconnected providing a sufficient acceptance of the said grating coupler or micro-optical interconnect providing multiple grating couplers for multiple cores can be designed according to the present invention.

The fiber alignment structures described can be engineered to fit a specific type of fiber according to its manufacturing tolerances to position the fiber core in a given targeted location, or withing a given tolerance of this location. Special material processing or additional post-processing or coating can be used to optimize the surface roughness, the rheology and/or the friction of the alignment structures with the fiber.

Additionally, to the alignment structures, an additional fabrication step can be used to fix the optical fiber in a given position within the alignment structures. Such process-step may be the addition of an adhesive, for example UV-curable to fix the fiber to the alignment structure or to its substrate, localized heating or the application of a given irradiation such as laser light or UV light to modify the interface between the alignment structures and the fiber outer surface or to modify the shape of the alignment structures, or this process step may be the use of (micro) mechanical clipping to fix a fiber in its position. These process steps are preferably executed in parallel to multiple fibers in parallel on a given array of optical interconnects or serially using a very fast process such as laser irradiation.

Fibers made of different materials such as polymers, silicon, silica and other ceramics for their core(s) and/or their cladding(s) and/or their buffer/coating as well as hollow fibers can be connected to micro-optical interconnected engineered with the suitable mechanical and optical properties according to the present invention.

### V) Simulation of a Micro-Deflector 30 of the Invention

FIG. 31 shows an example of a finite element method (FEM) simulation of a vertical cross section of a micro-deflector 30 of the invention that is used to optimize its geometry. A gaussian beam 2000 corresponding to the optical mode of the SMF-28 single mode waveguide 20 with a mode radius of 10.2 μm is radiated to the micro-deflector 30 having a radius of curvature of the 200 μm. Upon reflection of the internal light beam 2000′ from the reflective curved surface 32 (based on TIR) and due to the radius of curvature, the reflected optical beam 2002′ provides a focused light beam 2002 on the substrate 10 . In this example, a grating coupler is patterned on the surface of a SOI substrate and the optical mode is focused on the grating coupler. The vertical height of the micro-deflector determines the incident angle of the reflected beam 2002′ with respect to the substrate. The height here is optimized to so that the outcoupled light beam 2002 has an angle of 8 degrees relative to the normal of the substrate 10 and according to the design of the grating coupler. The process allows for full and independent control over the radius of the curvature and the reflector's height, allowing for efficient spot size conversion between the two facet of the micro-deflector and at the same time, complete freedom over the design of the incident angle and the position of the focal point.

### VI) Exemplary Applications

The micro-optical interconnect of the present invention may be used in various types of applications such as:
Angled fiber-to-fiber or fiber-to-chip connectivity
Self-aligned fiber to chip packaging (VCSEL, Photodiodes, PICs)
Optical projection from the chip to free space (LIDAR) or a panel (projector)
Chip to chip interconnection (using two mirrors facing each other on the two edges connected to two gratings)

### REFERENCES

[1] K. Schmidtke, F. Flens, A. Worrell, et al., “960 Gb/s Optical Backplane Ecosystem Using Embedded Polymer Waveguides and Demonstration in a 12G SAS Storage Array,” IEEE J. Lightwave Technol., 2013, 31, (24), pp. 3970-3974
[2] S.-P. Han, J. T. Kim, S.-W. Jung, et al., “A reflective curved mirror with low coupling loss for optical interconnection”, IEEE Photon. Technol. Lett., 2004, 16, (1), pp. 185-187
[3] M. H. Cho, S. H. Hwang, H. S. Cho, et al., “High-coupling-efficiency optical interconnection using a 90°-bent fiber array connector in optical printed circuit boards”, IEEE Photon. Technol. Lett., 2005, 17, (3), pp. 690-692
[4] K.-W. Jo, M.-S. Kim, J. H. Lee, et al., “Optical characteristics of a self-aligned microlens fabricated on sidewall of a 45°- angled optical fiber”, IEEE Photon. Technol. Lett., 2004, 16, (1), pp. 138-141.
[5] S. H. Hwang, J. Y. An, M.-H. Kim, et al., “VCSEL array module using (111) facet mirrors of a V-grooved silicon optical bench and angled fibers,” IEEE Photon. Technol. Lett., 2005, 17, (2), pp. 477-479
[6] R. Krähenbühl, J. Kunde, A-C Pliska, et al., “Compact 90° releasable multifiber optical connectivity solution”, IEEE Photon. Technol. Lett., 2007, 19, (8), pp. 580-582.
[7] M. Rossi, H. Rudmann et al., “Wafer-scale micro-optics replication technology” Proc. of SPIE, 2003, vol. 5183, pp. 148-154
[8] S. Haselbeck, H. Schreiber, J. Schwider, et al., “Micro-lenses fabricated by melting photoresist” Opt. Eng., 1993, 6 pp. 1322-4
[9] Y. Bellouard, et al. “Femtoprint: A femtosecond laser printer for micro- and nano-scale systems”, CLEO_AT.2012.ATu3L.3

1. A micro-optical interconnect component comprising an optical platform comprising a substrate defining a first substrate surface to adapt optical structures and a second surface opposite to said first surface said platform comprising arranged onto said first substrate at least one optical alignment structure
wherein
said at least one optical alignment structure is adapted to fix an optical component and/or arranged as alignment structure to adapt another interconnect component,
said optical platform comprises a light deflecting element arranged on said first surface and being made of a material having a refractive index higher than 1,
the light deflecting element comprises a first face, facing said optical alignment structure, and a second face facing said substrate to a second side, said first and said second side being connected by a curved surface being an optically reflecting surface,
the light deflecting element has a shape so that an incident light beam onto said first or second surface is deflected by an angle between 60° and 120°, said incident light beam may be provided from the outside or the inside of said substrate;
said light deflecting element has a total volume of less than 1 mm³;
at least said first surface and said curved surface have a root-mean-square rugosity of less than 10 nm.

2. The micro-optical interconnect according to claim 1 wherein said light deflecting element is configured to reflect more than 80% of light provided from said first face to said second surface or vice versa.

3. The micro-optical interconnect component according to claim 1 wherein said optical component is an optical waveguide and wherein the alignment structure is a waveguide alignment structure comprising at least two opposite walls to fix at least a portion of a length of said waveguide between said walls, said waveguide alignment structure facing said light deflecting element, to the side opposite to said curved reflecting surface.

4. The micro-optical interconnect component according to claim 3 wherein said waveguide is one of: an optical fiber, an optical fiber bundle, a fiber array or a multicore fiber.

5. The micro-optical interconnect component according to claim 1, wherein said curved surface has an aspherical shape, defined in at least one of said curved surface's cross-section planes.

6. The micro-optical interconnect component according to claim 1, wherein said light deflecting element is configured to focus an incident parallel beam on the first or second surface into a spot having a largest dimension of less than 50 μm, at said second, respectively first surface.

7. The micro-optical interconnect component according to any claim 1, wherein said substrate is made at least partially of one of the materials chosen among: glass, silicon, Si₃N₄, LiNbO₃, InP, GaP, GaAs or a combination of them.

8. The micro-optical interconnect component according to claim 3, wherein said waveguide alignment structure is made of a material chosen from: polymer, glass, silicon, sol-gel, reflective materials, or a combination of them.

9. The micro-optical interconnect component according to claim 1, wherein said reflective element is made of a material chosen from: a polymer, glass, silicon, sol-gel, or a combination of them.

10. The micro-optical interconnect component according to claim 1, wherein a grating coupler is arranged to said substrate and facing said reflective element.

11. The micro-optical interconnect component according to claim 1, wherein said grating coupler is made at least partially of Si₃N₄ or Silicon or LiNbO3 or InP, GaP, GaAs or a combination of them.

12. A micro-optical device comprising the micro-optical interconnect component according to claim 1, wherein at least a photodiode and/or a photodetector and/or a photosensitive material or layer, and/or a microlaser is arranged into and/or onto said substrate and being configured in optical communication with said reflective element.

13. The micro-optical device according to claim 12 wherein said microlaser is chosen among one of: a VCSEL, a laser diode, a micro-LED, a SLED.

14. A micro-optical system comprising:
at least one micro-optical device comprising the micro-optical interconnect component according to claim 1, wherein at least a photodiode and/or a photodetector and/or a photosensitive material or layer, and/or a microlaser is arranged into and/or onto said substrate and being configured in optical communication with said reflective element; and
at least one micro-optical interconnect component according to claim 1.

15. A micro-optical system comprising at least two micro-optical devices according to claim 12, said at least two micro-optical devices being arranged on a common platform.

16. A micro-optical system comprising at least two micro-optical interconnect components according to claim 1.

17. A micro-optical system according to claim 14, wherein at least two micro-optical devices are connected by said optical alignment structure.

18. A micro-optical system according to claim 14, wherein at least one micro-optical interconnect components and at least one micro-optical devices are interconnected mechanically by said optical alignment structures.

19. A method of fabrication of an array of micro-optical interconnect components, according to claim 1, on a single substrate, comprising the steps of:
providing a substrate defining an array of first surfaces;
providing a mold, comprising areas substantially transparent to UV light and other areas substantially opaque to UV light comprising a structured surface having an array of forms;
replicating by using said array of forms, an array of light deflecting elements and an array of alignment structures;
applying UV-curable material onto at least a predetermined area of said substrate;
aligning said structured surface onto a specific location relative to said predetermined areas and onto said UV-curable material;
providing UV-light onto a UV curable material, through said mold through the areas of the mold substantially transparent to UV light, so as to cure said UV curable material and realizing an array of light deflecting elements on an array on said substrate, and so that each of said light deflecting elements has at least one curved surface;
realizing an array of optical alignment structures on said substrate 10, each of said optical alignment structures facing a light deflecting element.

20. The method of fabrication of the micro-optical interconnect component according to claim 19 wherein said alignment structures comprise at least two walls for fixing an optical waveguide.

21. The method of fabrication of the micro-optical interconnect component according to claim 19, wherein said alignment structures are realized at the same time and with the same steps of the fabrication of the micro-deflectors.

22. The method of fabrication of the micro-optical interconnect component according to claim 19, wherein said optical substrate is made of a material chosen from: silicon, SOI (Silicon on Insulator), glass, quartz, LiNbO3, LNOI (lithium niobate on insulator), InP, GaP, GaAs substrate or a combination of them.

23. The method of fabrication of the micro-optical interconnect component according to claim 19, wherein a grating is arranged on said substrate and facing at least partially said optical deflectors.

24. The method of fabrication of the micro-optical interconnect component according to claim 23 wherein the grating is realized in a layer made of one of the materials: silicon (Si), Si3N4 LiNbO3 InP, GaP, GaAs, glass, a polymer.
